(19) United States
(12) Patent Application Publication
(10) Pub. No.: US 2014/0126147 A1
(43) Pub. Date: May 8, 2014

(54) CONTROL CIRCUIT FOR CONTROLLING COOLING FAN OF COMPUTER SYSTEM

(71) Applicant: Hon Hai Precision Industry Co., Ltd., New Taipei (TW)

(72) Inventor: CHUN-SHENG CHEN, New Taipei (TW)

(73) Assignee: HON HAI PRECISION INDUSTRY CO., LTD., New Taipei (TW)

(21) Appl. No.: 14/061,930

(22) Filed: Oct. 24, 2013

(30) Foreign Application Priority Data
Nov. 6, 2012 (CN) 201210437721X

(51) Int. Cl. G06F 1/20

(52) U.S. Cl. CPC G06F 1/20
USPC 361/695

(57) ABSTRACT

A control circuit for controlling rotation speed of a cooling fan of a computer system includes a temperature sensor, a controller, a switch component, and a current control circuit. The controller generates a pulse width modulation (PWM) signal according to a temperature sensed by the temperature sensor. The integral circuit converts the PWM signals into analog voltage signals and output the voltage signals to the switch component, to adjust a voltage output to the cooling fan from the current control circuit and to control the rotation speed of the cooling fan using the voltage output from the current control circuit.

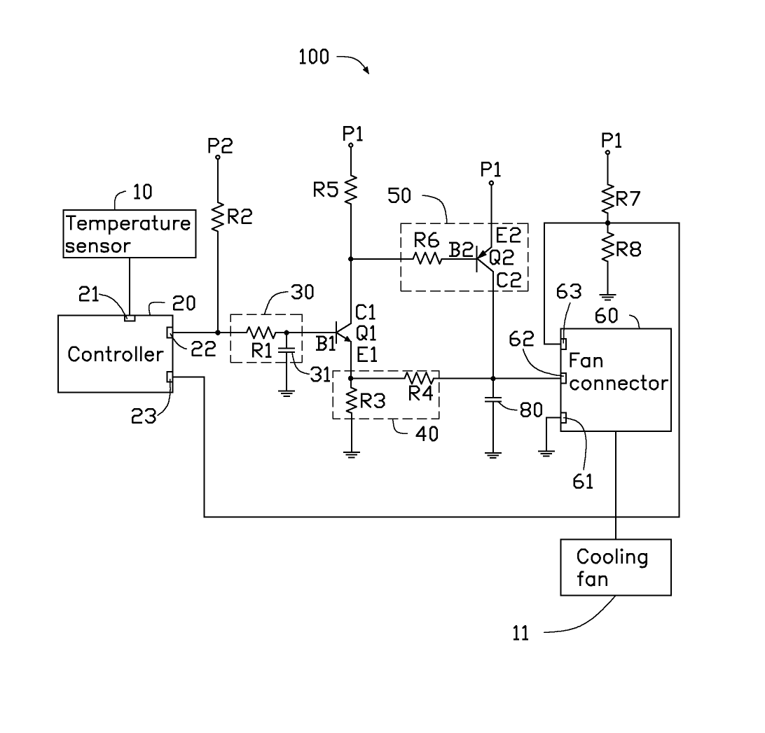

### BACKGROUND

1. Technical Field

Embodiments of the present disclosure relate to air cooling technologies of computer systems, and particularly to, a control circuit for controlling a cooling fan of a computer system.

2. Description of Related Art

Using cooling fans to cool computer systems is well known in the art. As components (e.g., processors, graphics cards, RAM and other components) in computer systems have increased in speed and power consumption, the amount of heat produced by these components has also increased. Thus, the cooling fans for cooling these components may need to work at a higher speed. Therefore, how to control the speed of the cooling fans according to the heat produced by the components is very important for the computer systems.

### BRIEF DESCRIPTION OF THE DRAWINGS

The FIGURE illustrates a schematic circuitry diagram of one embodiment of a control circuit for controlling a cooling fan of a computer system.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean “at least one”.

In the FIGURE, a circuitry diagram a control circuit 100 for controlling a cooling fan 11 of a computer system is shown. The control circuit 100 includes a temperature sensor 10, a controller 20, an integral circuit 30, a switch component Q1, a feedback circuit 40, a current control circuit 50, and a fan connector 60.

The temperature sensor 10 is configured to sense a real-time temperature of the computer system (not shown). In other embodiments, the temperature sensor 10 may be configured to sense a real-time temperature of a particular component (e.g., a processor, or a graphic card) of the computer system.

The controller 20 includes a temperature sensing pin 21, a signal output pin 22 and a signal feedback pin 23. The temperature sensing pin 21 is electrically connected to the temperature sensor 10, to acquire the real-time temperature sensed by the temperature sensor 10. The controller 20 generates a pulse width modulation (PWM) signal having a duty cycle representative of the real-time temperature sensed by the temperature sensor 10, and outputs the PWM signal via the signal output pin 22 to control the rotation speed of the cooling fan 11. The signal output pin 22 is electrically connected to a power source P2 via a pull-up resistor R2 to ensure that a logical level of the output PWM signals settle at an expected logical high level, such as 3V. In the embodiment, the controller 20 may be, for example, a super input/output (I/O) chip of the computer system.

The integral circuit 30 includes an integral resistor R1 and an integral capacitor 31. One end of the integral resistor R1 is connected to the signal output pin 22 of the controller to receive the PWM signals generated by the controller 20, another end of the integral resistor R1 is connected to an end of the integral capacitor 31, and another end of the integral capacitor is ground.

The switch component Q1 is an npn-type transistor which includes a first base electrode B1, an first emitter electrode E1, and a first collector electrode C1. The feedback circuit 40 includes a first feedback resistor R3 and a second feedback resistor R4. The current control circuit 50 includes a current limiting resistor R6 and a current control component Q2. In the embodiment, the current control component Q2 is a pnp-type transistor which includes a second base electrode B2, a second emitter electrode E2, and a second collector electrode C2. The first base electrode B1 is electrically connected to a node between the integral resistor R1 and the integral capacitor 31. The first collector electrode C1 is connected a power source P1 via a second pull-up resistor R5 and is connected to the second base electrode B2 via the current limiting resistor R6. The second emitter electrode E2 is connected to a power source P1. The first feedback resistor R3 is connected to the second feed back resistor R4 and is ground. The second feedback resistor R4 is connected between the first emitter electrode E1 of the switch component Q1 and the second collector electrode C2 of the current limiting component Q2. Further, in this embodiment, the second collector electrode C2 is connected to a filter capacitor 80. The filter capacitor 80 is ground.

The fan connector 60 is configured to connect the cooling fan 11. The fan connector 60 includes a first pin 61, a second pin 62, and a third pin 63. The first pin 61 is a ground pin of the fan connector 60. The second pin 62 is a power pin to supply power for the cooling fan 11 and is connected to the second collector electrode C2 of the current control component Q2. The third pin 63 is a detection pin configured to detect the rotation speed of the cooling fan 11. The third pin 63 is connected to the signal feedback pin 23 of the controller 20 to feedback the detected rotation speed of the cooling fan 11 to the controller 20 in real-time. In the embodiment, the third pin 63 is connected to the power source P1 via a first voltage dividing resistor R7 and is connected to the ground via a second voltage dividing resistor R8.

The working principle of the control circuit 100 are described below. When the controller 20 detects that the temperature sensed by the temperature sensor 10 increases, the controller 20 increases the duty cycle of the PWM signals. The PWM signals is converted into analog voltage signals which are output to the first base electrode B1 of the switch component Q1 to raise a voltage (e.g., Vb1) of the first base electrode B1. Correspondingly, both a current (e.g., Ib1) of the first base electrode B1 and a current (e.g., Ic1) of the first collector electrode C1 are raised. Since a voltage (e.g., Vc1) of the first collector electrode C1 is equal to P1−R5×Ic1, the voltage Vc1 of the first collector electrode C1 which is output to the second base electrode B2 is decreased, thereby making the current control component Q2 being further conducted and a voltage drop between the second emitter electrode E2 and the second collector electrode C2 is decreased. Thus, a voltage (e.g., Vc2) of the second collector electrode C2 which is output to the second pin 62 of the fan connector 60 via the second collector electrode is increased. Accordingly, the rotation speed of the cooling fan 11 is raised.

Additionally, the voltage Vc2 of the second collector electrode C2 is feedback to the first emitter electrode E1 via the feedback circuit 40. When a voltage difference between the first base electrode B1 and the first emitter electrode E1 is less than a threshold value (e.g., 0.7V), the first switch component Q1 is turned off and the voltage Vc2 output to the second pin 62 of the fan connector 60 is stabilized to keep the cooling fan 11 to work at a stable rotation speed.

In contrast, according to the similar principle described above, when the controller 20 detects that the temperature sensed by the temperature sensor 10 decreases, the controller 20 decreases the duty cycle of the PWM signals. Thus, the rotation speed of the cooling fan 11 is slowed down correspondingly.

In view of the above, the control circuit 100 of this invention can control the rotation speed of the cooling fan 11 of the computer system according to a detected real-time temperature of the computer system. Further, the control circuit 100 uses transistors and PWM signals to control the rotation speed of the cooling fan 11, which has a high control precision.

Although certain embodiments of the present disclosure have been specifically described, the present disclosure is not to be construed as being limited thereto. Various changes or modifications may be made to the present disclosure without departing from the scope and spirit of the present disclosure.

What is claimed is:

1. A control circuit, comprising:
a temperature sensor configured to sense a real-time temperature of a computer system;
a controller connected to the temperature sensor and configured to generates a pulse width modulation (PWM) signal representative of the real-time temperature sensed by the temperature sensor;
an integral circuit connected to the controller and configured to convert the PWM signals into analog voltage signals;
a switch component having a first base electrode, a first collector electrode, and a first emitter electrode, wherein the first base electrode is connected to the integral circuit for receiving the analog voltage signals, and first collector electrode is connected to a first power source; and
a current control component having a second base electrode, a second collector electrode, and a second emitter electrode, wherein the second base electrode is connected to the first collector electrode via a current limiting resistor, the second emitter electrode is connected to the first power source, and the second collector electrode is connected to a cooling fan of the computer system via a fan connector to supply voltage to the cooling fan.

2. The control circuit according to claim 1, wherein the switch component is an npn-type transistor and the current control unit is a pnp-type transistor.

3. The control circuit according to claim 1, wherein when the detected real-time temperature increases, the controller increases a duty cycle of the PWM signals to raise the rotation speed of the cooling fan; and when the detected real-time temperature decreases, the controller decreases the duty cycle of the PWM signals to slow down the rotation speed of the cooling fan.

4. The control circuit according to claim 1, wherein the controller comprises a temperature sensing pin and signal output pin, the integral circuit comprises an integral resistor and an integral capacitor, the temperature sensing pin is connected to the temperature sensor to acquire the real-time temperature sensed by the temperature sensor, one end of the integral resistor is connected to the signal output pin of the controller to receive the PWM signals generated by the controller, another end of the integral resistor is connected to an end of the integral capacitor, and another end of the integral capacitor is ground.

5. The control circuit according to claim 4, wherein the signal output pin of the controller is connected to a second power source via a first pull-up resistor.

6. The control circuit according to claim 1, further comprising a feedback circuit connected between the first emitter electrode and the fan connector, to feedback the voltage output from the second collector electrode to the switch component.

7. The control circuit according to claim 6, wherein the feedback circuit comprises a first feedback resistor and a second resistor, the first feedback resistor is connected to the second feed back resistor and is ground, and the second feedback resistor is connected between the first emitter electrode of the switch component and the second collector electrode of the current limiting component.

8. The control circuit according to claim 1, wherein the controller further comprises a feedback pin connected to the fan connector, to receive the rotation speed of the cooling fan detected by the fan connector.

9. The control circuit according to claim 1, wherein first collector electrode of the switch component is connected to the first power source via a second pull-up resistor.

10. The control circuit according to claim 1, further comprising a filter capacitor connected between the second collector electrode and a ground.

11. The control circuit according to claim 1, wherein the controller is a super input/output (I/O) chip of the computer system.
